(19) United States
(12) Patent Application Publication
(10) Pub. No.: US 2011/0008152 A1
(43) Pub. Date: Jan. 13, 2011

(54) TRANSFER DEVICE AND BLOWER HAVING THE SAME

(75) Inventor: Xiang LIU, Zhongshan (CN)

Correspondence Address: MATTHIAS SCHOLL, 14781 MEMORIAL DRIVE, SUITE 1319, HOUSTON, TX, 77079, US

(73) Assignee: Zhongshan Broad-Ocean Motor Co., Ltd., Zhongshan (CN)

(21) Appl. No.: 12/830,365

(22) Filed: Jul. 5, 2010

(30) Foreign Application Priority Data
Jul. 8, 2009 (CN) 200920060396.3

(51) Int. Cl. F04D 29/00; F16L 9/00

(52) U.S. Cl. 415/121.3; 138/177

(57) ABSTRACT

A transfer device having an inlet member, an outlet member, and a transition member. The inlet member is connected with the outlet member via the transition member; the inlet member, the outlet member, and the transition member are one-step cast; and the transition member is tilted upwards so that the inlet member is not in line with the outlet member vertically. The assembly and disassembly of the transfer device is very easy, which facilitates the connection of a blower and user equipment; and the transfer device is one-step cast with a metal material and has a simple structure, which greatly reduces the molding and manufacturing time, simplifies the production process, and saves the production cost. A blower utilizing the transfer device is also provided.

### CROSS-REFERENCE TO RELATED APPLICATIONS

Pursuant to 35 U.S.C. §119 and the Paris Convention Treaty, this application claims the benefit of Chinese Patent Application No. 200920060396.3 filed Jul. 8, 2009, the contents of which are incorporated herein by reference.

### BACKGROUND OF THE INVENTION

1. Field of the Invention

The invention relates to a transfer device and a blower having the same.

2. Description of the Related Art

Conventional blower outlet is generally rectangular, if connected to an external pipe having different shape such as circular, a transfer device must be installed. Currently there are some kinds of transfer devices of blowers, but they are assembled from several separate components which are involved in many manufacturing processes and need be molded firstly, resulting in high cost. Moreover, the assembly itself is very difficult and has a complex process. Thus, conventional transfer devices for blowers are inconvenient for use.

### SUMMARY OF THE INVENTION

In view of the above-described problems, it is one objective of the invention to provide a transfer device which is one-step cast with a metal material by a simple process and thereby has low cost.

It is another objective of the invention to provide a blower having a transfer device which is one-step cast with a metal material by a simple process and thereby has low cost.

To achieve the above objectives, in accordance with one embodiment of the invention, there is provided a transfer device which is one-step cast with a metal material by a simple process and thereby has low cost, the transfer device comprising an inlet member, an outlet member, a transition member, wherein the inlet member is connected with the outlet member via the transition member; the inlet member, the outlet member, and the transition member are one-step cast; and the transition member is tilted upwards so that the inlet member is not in line with the outlet member vertically.

In a class of this embodiment, the inlet member is rectangular, the outlet member is circular, and the transfer device is one-step cast with aluminum or an aluminum alloy.

In a class of this embodiment, a convex plate is disposed prominently upwards on the internal bottom surface of the inlet member, and there is a gap between each side of the convex plate and corresponding side wall of the inlet member.

In a class of this embodiment, a plurality of holes is disposed on three other end faces (i.e., both side walls and a top wall) of the inlet member.

In a class of this embodiment, a total length L of the transfer device is between 55 and 65 mm; a length L1 of the inlet member is between 10 and 17 mm, a width W thereof is between 65 and 80 mm, and a height H thereof is between 40 and 50 mm; a length L2 of the outlet member is between 12 and 18 mm, and a diameter D thereof is between 90 and 120 mm; a tilt angle α between the bottom surface of the inlet member and the bottom end of the outlet member is between 18 and 25°; and a tilt angle β between the top surface of the inlet member and the top end of the outlet member is between 50 and 75°.

In accordance with another embodiment of the invention, there is provided a blower having a transfer device which is one-step cast with a metal material by a simple process and thereby has low cost, the blower comprising a motor, an impeller, and a casing, the motor being disposed on the casing, an air inlet being disposed at the bottom of the casing, an air outlet being disposed at the side of the casing, the impeller being disposed in a chamber formed by the casing and installed on a shaft of the motor, wherein the transfer device is disposed on the air outlet and comprises an inlet member, an outlet member, a transition member; the inlet member is connected with the outlet member via the transition member; the inlet member, the outlet member, and the transition member are one-step cast; and the transition member is tilted upwards so that the inlet member is not in line with the outlet member vertically.

In a class of this embodiment, the inlet member is rectangular, the outlet member is circular, and the transfer device is one-step cast with aluminum or an aluminum alloy.

In a class of this embodiment, a convex plate is disposed prominently upwards on the internal bottom surface of the inlet member, and there is a gap between each side of the convex plate and corresponding side wall of the inlet member; the convex plate is embedded into the internal bottom surface of the air outlet, the bottom surface of the inlet member is inside the internal bottom surface of the air outlet, and each side wall of the air outlet is exactly embedded into corresponding gap of the inlet member.

In a class of this embodiment, a plurality of holes is disposed on three other end faces (i.e., both side walls and a top wall) of the inlet member, a screw hole is disposed on corresponding end face of the air outlet, and the transfer device is locked by screwing an external screw through the screw hole and the hole.

In a class of this embodiment, a total length L of the transfer device is between 55 and 65 mm; a length L1 of the inlet member is between 10 and 17 mm, a width W thereof is between 65 and 80 mm, and a height H thereof is between 40 and 50 mm; a length L2 of the outlet member is between 12 and 18 mm, and a diameter D thereof is between 90 and 120 mm; a tilt angle α between the bottom surface of the inlet member and the bottom end of the outlet member is between 18 and 25°; and a tilt angle β between the top surface of the inlet member and the top end of the outlet member is between 50 and 75°.

Advantages of the invention are summarized below:
1. The assembly and disassembly of the transfer device is very easy, which facilitates the connection of a blower and user equipment;
2. The transfer device is one-step cast with a metal material and has a simple structure, which greatly reduces the molding and manufacturing time, simplifies the production process, and saves the production cost;
3. The convex plate of the transfer device is embedded into the inside of the bottom of the air outlet, each side wall of the air outlet is exactly embedded into the corresponding gap of the inlet member of the transfer device, which ensures the bottom of the inlet member and the bottom of the air outlet maintain level and stable; and
4. The dimension tolerance of the transfer device is very practicable, which results in low wind resistance and smooth outlet air.

### BRIEF DESCRIPTION OF THE DRAWINGS

The invention is described hereinbelow with reference to accompanying drawings, in which:

FIG. 1 is a schematic diagram of a transfer device according to one embodiment of the invention;

FIG. 2 is a plan view of FIG. 1;

FIG. 3 is a cross-sectional view take from line A-A of FIG. 2;

FIG. 4 is a schematic diagram of a blower according to one embodiment of the invention;

FIG. 5 is a schematic diagram of the blower of FIG. 4 from another observation angle; and

FIG. 6 is a schematic diagram of the blower of FIG. 4 prior to assembly of a transfer device.

### DETAILED DESCRIPTION OF THE EMBODIMENTS

For further illustrating the invention, experiments detailing a transfer device and a blower having the same are described below. It should be noted that the following examples are intended to describe and not to limit the invention.

### Embodiment 1

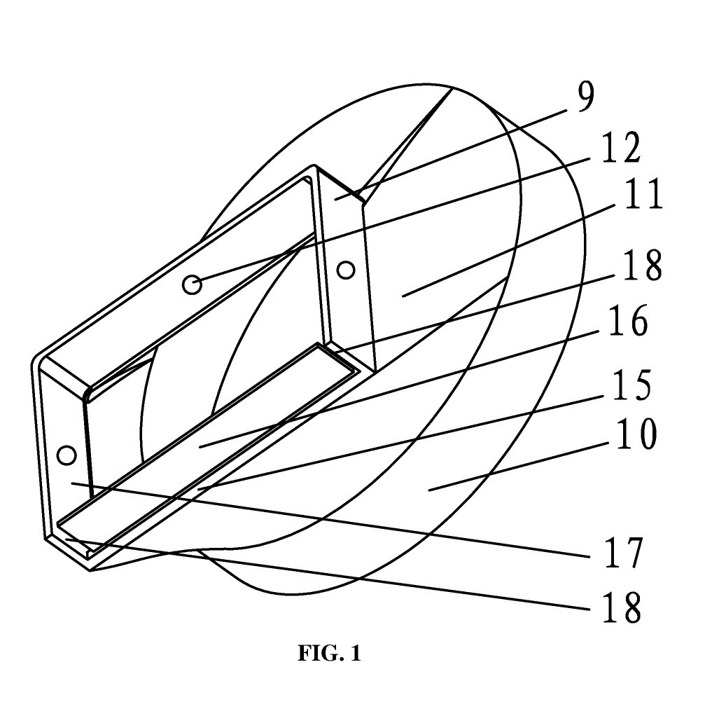

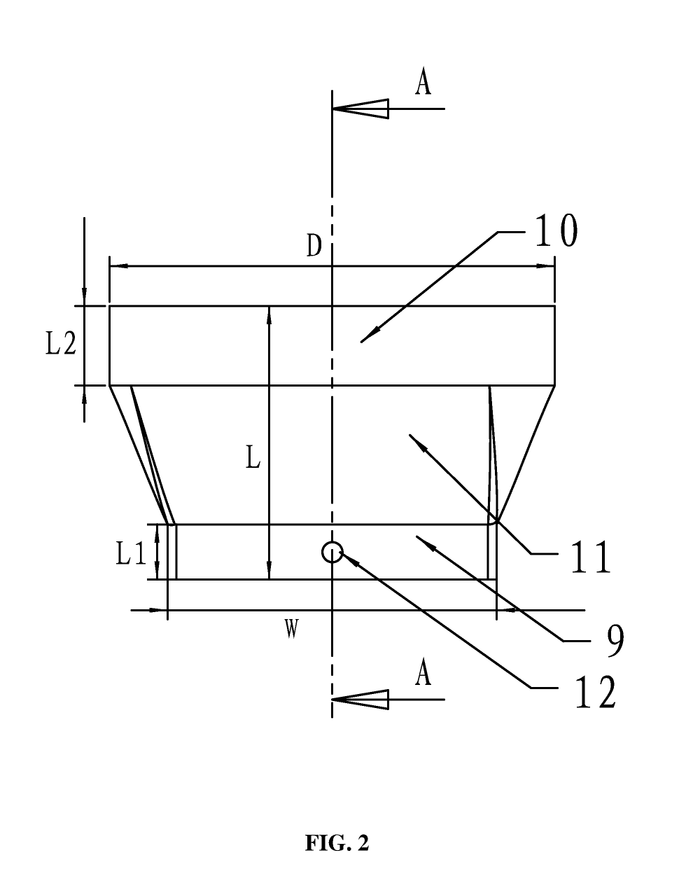

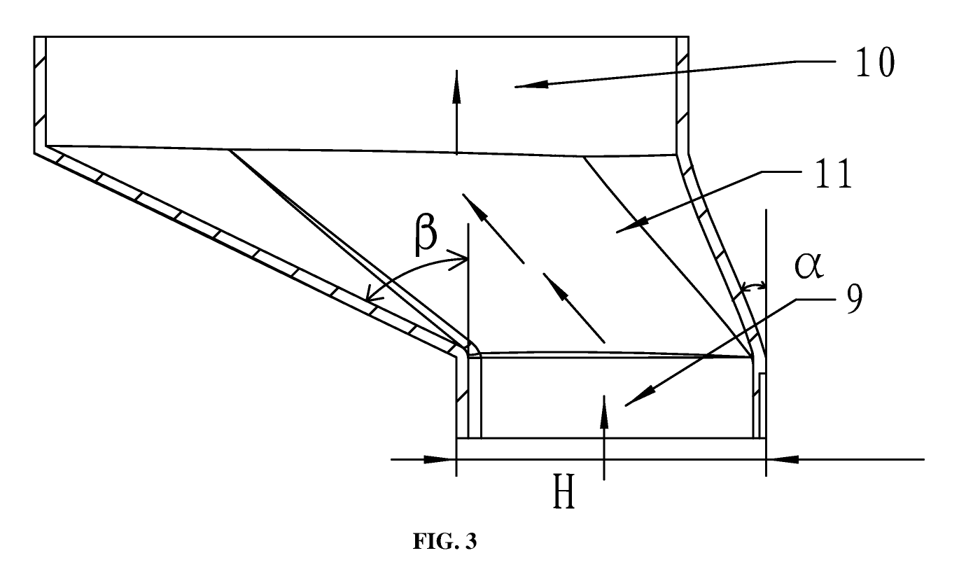

As shown in FIGS. 1-3, a transfer device comprises an inlet member 9, an outlet member 10, a transition member 11; the inlet member 9 is connected with the outlet member 10 via the transition member 11; the inlet member 9, the outlet member 10, and the transition member 11 are one-step cast; and the transition member 11 is tilted upwards so that the inlet member 9 is not in line with the outlet member 10 vertically.

The inlet member 9 is rectangular, the outlet member 10 is circular, and the transfer device is one-step cast with aluminum or an aluminum alloy. A convex plate 16 is disposed prominently upwards on the internal bottom surface 15 of the inlet member 9, and there is a gap 18 between each side of the convex plate 16 and corresponding side wall 17 of the inlet member 9. A plurality of holes 12 is disposed on three other end faces (i.e., both side walls and a top wall) of the inlet member 9. Air flows in the inlet member 9, flows through the transition member 11, and flow out of the outlet member 10.

A total length L of the transfer device is between 55 and 65 mm; a length L1 of the inlet member 9 is between 10 and 17 mm, a width W thereof is between 65 and 80 mm, and a height H thereof is between 40 and 50 mm; a length L2 of the outlet member 10 is between 12 and 18 mm, and a diameter D thereof is between 90 and 120 mm; a tilt angle α between the bottom surface 15 of the inlet member 9 and the bottom end of the outlet member 10 is between 18 and 25°; and a tilt angle β between the top surface of the inlet member 9 and the top end of the outlet member 10 is between 50 and 75°.

### Embodiment 2

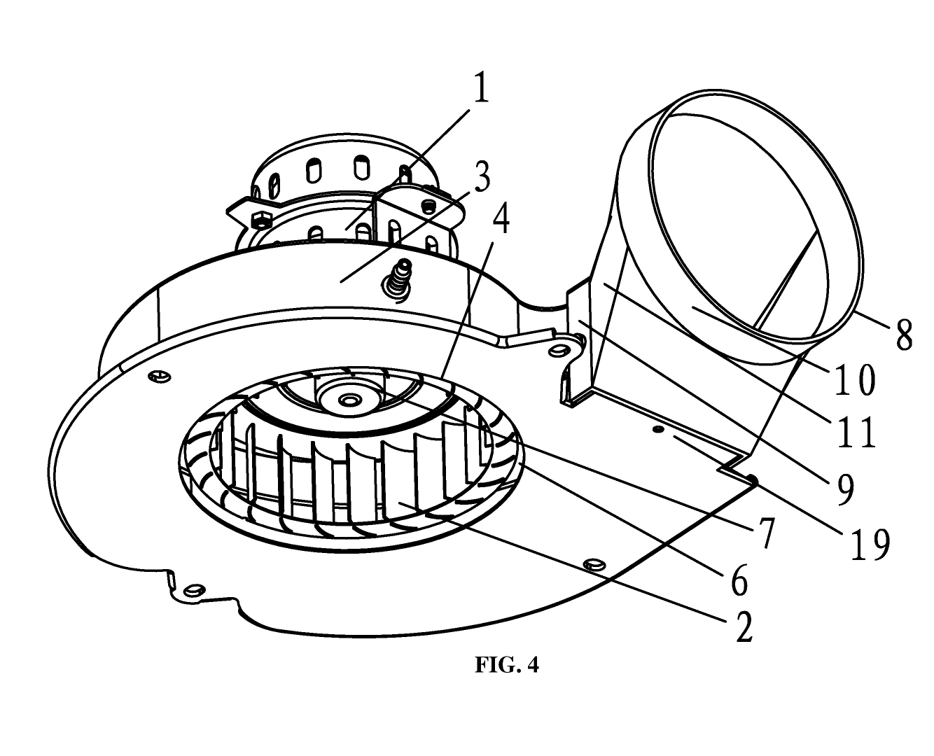

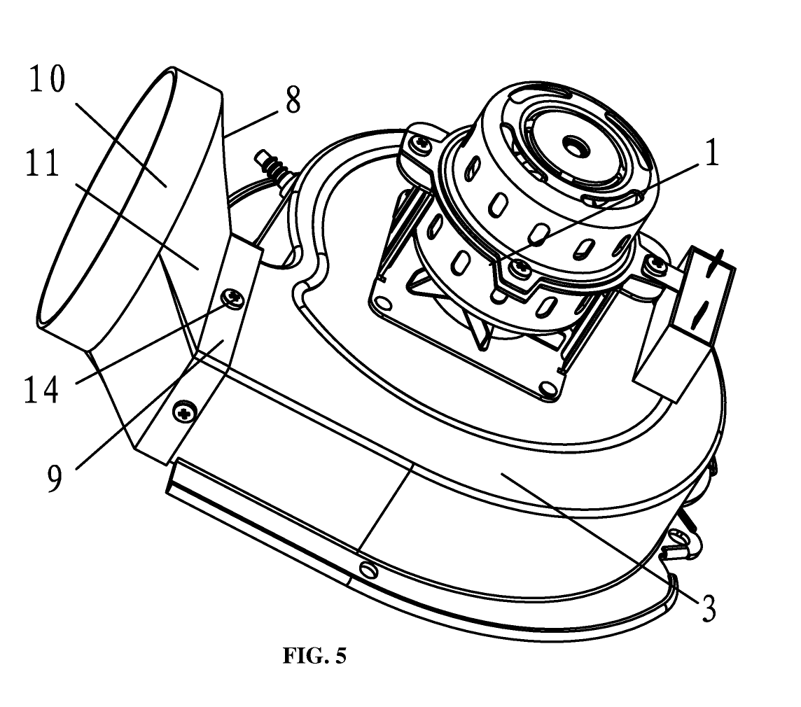

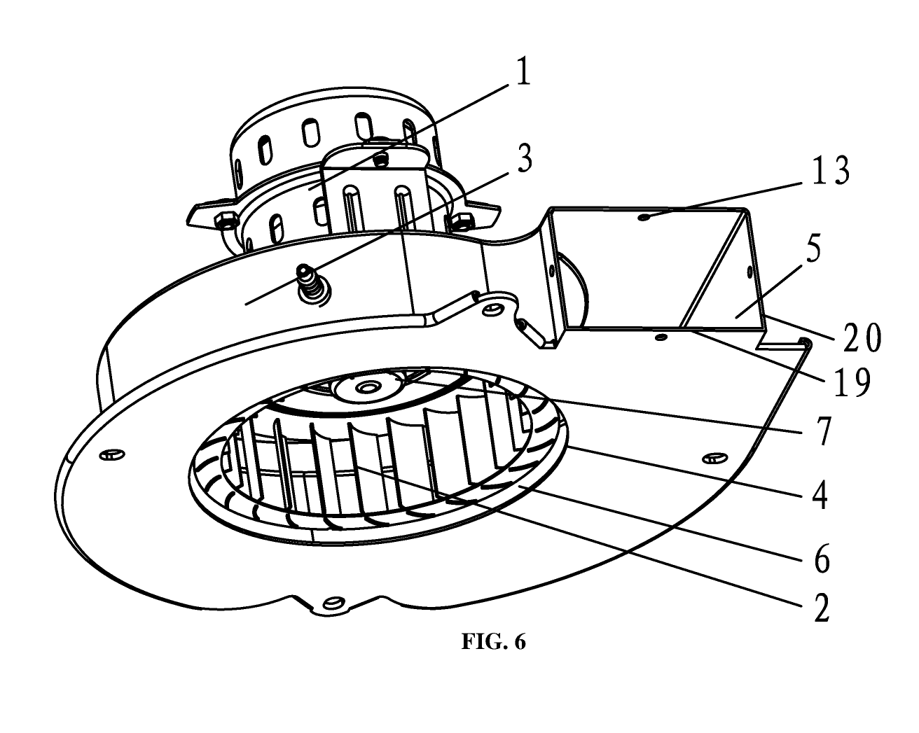

As shown in FIGS. 4-6, a blower has been equipped with a transfer device. The blower comprises a motor 1, an impeller 2, and a casing 3, the motor 1 being disposed on the casing 3, an air inlet 4 being disposed at the bottom of the casing 3, an air outlet 5 being disposed at the side of the casing 3, the impeller 2 being disposed in a chamber 6 formed by the casing 3 and installed on a shaft 7 of the motor 1; the transfer device 8 is disposed on the air outlet 5 and comprises an inlet member 9, an outlet member 10, a transition member 11; the inlet member 9 is connected with the outlet member 10 via the transition member 11; the inlet member 9, the outlet member 10, and the transition member 11 are one-step cast; and the transition member 11 is tilted upwards so that the inlet member 9 is not in line with the outlet member 10 vertically.

As shown in FIGS. 1-6, the inlet member 9 is rectangular, the outlet member 10 is circular, and the transfer device 8 is one-step cast with aluminum or an aluminum alloy. A convex plate 16 is disposed prominently upwards on the internal bottom surface 15 of the inlet member 9, and there is a gap 18 between each side of the convex plate 16 and corresponding side wall 17 of the inlet member 9. The convex plate 16 is embedded into the internal bottom surface 19 of the air outlet 5, the bottom surface 15 of the inlet member 9 is inside the internal bottom surface 19 of the air outlet 5, and each side wall 20 of the air outlet 5 is exactly embedded into corresponding gap 18 of the inlet member 9. A plurality of holes 12 is disposed on three other end faces (i.e., both side walls and a top wall) of the inlet member 9. A screw hole 13 is disposed on corresponding end face of the air outlet 5 and corresponds to the holes 12, and the transfer device 8 is locked by screwing an external screw 14 through the screw hole 13 and the hole 12. Air flows out of the air outlet 5 of the casing 3, flows in the inlet member 9 of the transfer device 8, flows through the transition member 11, and flow out of the outlet member 10.

A total length L of the transfer device 8 is between 55 and 65 mm; a length L1 of the inlet member 9 is between 10 and 17 mm, a width W thereof is between 65 and 80 mm, and a height H thereof is between 40 and 50 mm; a length L2 of the outlet member 10 is between 12 and 18 mm, and a diameter D thereof is between 90 and 120 mm; a tilt angle α between the bottom surface 15 of the inlet member 9 and the bottom end of the outlet member 10 is between 18 and 25°; and a tilt angle β between the top surface of the inlet member 9 and the top end of the outlet member 10 is between 50 and 75°.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A transfer device, comprising:
a) an inlet member (9);
b) an outlet member (10); and
c) a transition member (11);
wherein
said inlet member (9) is connected with said outlet member (10) via said transition member (11);
said inlet member (9), said outlet member (10), and said transition member (11) are one-step cast; and
said transition member (11) is tilted upwards so that said inlet member (9) is not in line with said outlet member (10) vertically.

2. The transfer device of claim 1, wherein said inlet member (9) is rectangular, said outlet member (10) is circular, and said transfer device is one-step cast with aluminum or an aluminum alloy.

3. The transfer device of claim 2, wherein a convex plate (16) is disposed prominently upwards on said internal bottom surface (15) of said inlet member (9), and there is a gap (18) between each side of said convex plate (16) and corresponding side wall (17) of said inlet member (9).

4. The transfer device of claim 2, wherein a plurality of holes (12) is disposed on both side walls and a top wall of said inlet member (9).

5. The transfer device of claim 2, wherein a total length L of said transfer device is between 55 and 65 mm; a length L1 of said inlet member (9) is between 10 and 17 mm, a width W thereof is between 65 and 80 mm, and a height H thereof is between 40 and 50 mm; a length L2 of said outlet member (10) is between 12 and 18 mm, and a diameter D thereof is between 90 and 120 mm; a tilt angle α between said bottom surface (15) of said inlet member (9) and the bottom end of said outlet member (10) is between 18 and 25°; and a tilt angle β between the top surface of said inlet member (9) and the top end of said outlet member (10) is between 50 and 75°.

6. The transfer device of claim 1, wherein a convex plate (16) is disposed prominently upwards on said internal bottom surface (15) of said inlet member (9), and there is a gap (18) between each side of said convex plate (16) and corresponding side wall (17) of said inlet member (9).

7. The transfer device of claim 1, wherein a plurality of holes (12) is disposed on both side walls and a top wall of said inlet member (9).

8. The transfer device of claim 1, wherein a total length L of said transfer device is between 55 and 65 mm; a length L1 of said inlet member (9) is between 10 and 17 mm, a width W thereof is between 65 and 80 mm, and a height H thereof is between 40 and 50 mm; a length L2 of said outlet member (10) is between 12 and 18 mm, and a diameter D thereof is between 90 and 120 mm; a tilt angle α between said bottom surface (15) of said inlet member (9) and the bottom end of said outlet member (10) is between 18 and 25°; and a tilt angle β between the top surface of said inlet member (9) and the top end of said outlet member (10) is between 50 and 75°.

9. A blower, comprising:
a) a motor (1);
b) an impeller (2);
c) a casing (3);
d) an air inlet (4);
e) an air outlet (5); and
f) a transfer device (8),
wherein
said motor (1) is disposed on said casing (3);
said air inlet (4) is disposed at the bottom of said casing (3);
said air outlet (5) is disposed at the side of said casing (3);
said impeller (2) is disposed in a chamber (6) formed by said casing (3) and installed on a shaft (7) of said motor (1); and
said transfer device (8) is disposed on said air outlet (5) and comprises an inlet member (9), an outlet member (10), a transition member (11); said inlet member (9) is connected with said outlet member (10) via said transition member (11); said inlet member (9), said outlet member (10), and said transition member (11) are one-step cast; and said transition member (11) is tilted upwards so that said inlet member (9) is not in line with said outlet member (10) vertically.

10. The blower of claim 9, wherein said inlet member (9) is rectangular, said outlet member (10) is circular, and said transfer device (8) is one-step cast with aluminum or an aluminum alloy.

11. The blower of claim 10, wherein a convex plate (16) is disposed prominently upwards on said internal bottom surface (15) of said inlet member (9), and there is a gap (18) between each side of said convex plate (16) and corresponding side wall 17 of said inlet member (9); said convex plate (16) is embedded into the internal bottom surface (19) of said air outlet (5), said bottom surface (15) of said inlet member (9) is inside the internal bottom surface (19) of said air outlet (5), and each side wall (20) of said air outlet (5) is exactly embedded into corresponding gap (18) of said inlet member (9).

12. The blower of claim 10, wherein a plurality of holes (12) is disposed on both side walls and a top wall of said inlet member (9); a screw hole (13) is disposed on corresponding end face of said air outlet (5) and corresponds to said holes (12), and said transfer device (8) is locked by screwing an external screw (14) through said screw hole (13) and said hole (12).

13. The blower of claim 10, wherein a total length L of said transfer device (8) is between 55 and 65 mm; a length L1 of said inlet member (9) is between 10 and 17 mm, a width W thereof is between 65 and 80 mm, and a height H thereof is between 40 and 50 mm; a length L2 of said outlet member (10) is between 12 and 18 mm, and a diameter D thereof is between 90 and 120 mm; a tilt angle α between said bottom surface (15) of said inlet member (9) and the bottom end of said outlet member (10) is between 18 and 25°; and a tilt angle β between the top surface of said inlet member (9) and the top end of said outlet member (10) is between 50 and 75°.

14. The blower of claim 9, wherein a convex plate (16) is disposed prominently upwards on the internal bottom surface (15) of said inlet member (9), and there is a gap (18) between each side of said convex plate (16) and corresponding side wall 17 of said inlet member (9); said convex plate (16) is embedded into the internal bottom surface 19 of said air outlet 5, said bottom surface (15) of said inlet member (9) is inside the internal bottom surface (19) of said air outlet (5), and each side wall (20) of said air outlet (5) is exactly embedded into corresponding gap (18) of said inlet member (9).

15. The blower of claim 9, wherein a plurality of holes (12) is disposed on both side walls and a top wall of said inlet member (9); a screw hole (13) is disposed on corresponding end face of said air outlet (5) and corresponds to said holes (12), and said transfer device (8) is locked by screwing an external screw (14) through said screw hole (13) and said hole (12).

16. The blower of claim 9, wherein a total length L of said transfer device (8) is between 55 and 65 mm; a length L1 of said inlet member (9) is between 10 and 17 mm, a width W thereof is between 65 and 80 mm, and a height H thereof is between 40 and 50 mm; a length L2 of said outlet member (10) is between 12 and 18 mm, and a diameter D thereof is between 90 and 120 mm; a tilt angle α between said bottom surface (15) of said inlet member (9) and the bottom end of said outlet member (10) is between 18 and 25°; and a tilt angle β between the top surface of said inlet member (9) and the top end of said outlet member (10) is between 50 and 75°.
